(19) United States
(12) Patent Application Publication
(10) Pub. No.: US 2020/0097907 A1
(43) Pub. Date: Mar. 26, 2020

(54) OPTIMIZATION OF BATCH REQUESTS

(71) Applicant: SAP SE, Walldorf (DE)

(72) Inventors: Leiyi Yao, Shanghai (CN); Wenjun Zhou, Shanghai (CN); Wen-Syan Li, Shanghai (CN)

(21) Appl. No.: 16/137,363

(22) Filed: Sep. 20, 2018

(51) Int. Cl. G06Q 10/08

(52) U.S. Cl. CPC G06Q 10/08355

(57) ABSTRACT

In one embodiment, a method receives requests where each request includes an origin, a destination, a time dependency, a request, and a cost of the request. Lines are generated from the requests with each line including a duration from the time dependency, the origin, the destination, and a profit based on the cost. Paths are generated that include a set of lines with each path including an identification of the lines in the path, a set of requests in the path, and a weight based on the profit of the set of requests in the path. The paths are analyzed to select a number of paths from the paths based on the weight of each path. A schedule to fulfill the requests is then output. A combination of requests is assigned to a single entity based on a set of requests in a path selected for the single entity.

### BACKGROUND

A company may receive multiple requests, such as a batch ordering of goods or services, periodically (e.g., every day). Each request may have a different characteristics, such as an origin, a destination, a pick-up time, a price, and some request specific requirements (e.g., a type of vehicle). The company needs to fulfill the requests and meet the requirements. The company would also like to optimize the fulfillment of the requests and minimize cost. However, due to the different combinations of requests and requirements, the optimization may be very complex.

In one example, if the requests are in the delivery space, the company may need to take into account many variables, such as the number of vehicles to use, the transportation route, and the timetable for each vehicle. Also, the pick-up time and duration of each request may be different and the company may want to optimize the timetable and route for each vehicle. However, the company would like to minimize the number of vehicles to minimize the cost. The company also has to consider the specific requirements, such as vehicle types, and different vehicle types may have different costs. Further, other restrictions may be imposed, such as a maximum waiting time for vehicles when servicing multiple requests.

The analysis of the above variables to optimize the routes takes a large amount of computing resources and time. As the number of requests increases, the time to optimize the routes also increases. Due to the real-time nature of fulfilling the requests, the time and computing resources taken to optimize the routes needs to be efficient. However, due to the complexity of the analysis, a company's route optimization may not meet the time requirements and the company may generate inefficient routes.

### BRIEF DESCRIPTION OF THE DRAWINGS

FIG. 1 depicts a simplified system for optimizing requests according to some embodiments.

FIG. 2 depicts a simplified flowchart of a method for optimizing requests according to some embodiments.

FIG. 3A depicts a table that stores information for requests from a first destination (e.g., A) to a second destination (e.g., B) according to some embodiments.

FIG. 3B depicts a table that stores information for requests from the second destination to the first destination according to some embodiments.

FIG. 3C shows an example of a table that includes information for the lines that are generated according to some embodiments.

FIG. 3D depicts a table that includes information for the paths according to some embodiments.

FIG. 4A depicts an example of a process that is called to generate the paths according to some embodiments.

FIG. 4B shows a process for generating the paths according to some embodiments.

FIG. 4C depicts a process that optimizes the paths according to some embodiments.

FIG. 5 depicts a more detailed example of the server system according to some embodiments.

FIG. 6A shows a table that is stored for requests according to some embodiments.

FIG. 6B depicts an example of a table that summarizes information for the lines according to some embodiments.

FIG. 6C depicts an example of a table that describes the paths according to some embodiments.

FIG. 6D depicts a table that maps paths to lines according to some embodiments.

FIG. 6E depicts a table in a database that maps paths to requests according to some embodiments.

FIG. 6F depicts a table that describes a schedule according to some embodiments.

FIG. 7 illustrates hardware of a special purpose computing machine configured with a request optimizer according to one embodiment.

### DETAILED DESCRIPTION

Described herein are techniques for a batch request processing system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

Some embodiments optimize a number of batch requests. For example, the requests may be serviced by a provider, such as the request may be orders for goods or services, but other requests can be optimized. As used herein, the term request and order may be used interchangeably. The requests may include characteristics, such as an origin, a destination, a time-dependency, an order, and a cost of the request. Additionally, some requests may have special requirements, such as delivery special requests. A system considers the origin and destination for each request in addition to a time dependency (e.g., the duration needed to fulfill the request). Also, the system determines a profit for the request based on the cost of the request and revenue received. Then, the system generates a plurality of lines from the request where each line includes a duration from the time dependency, the origin, the destination, and a profit for the request. Each line may refer to one of the requests.

The system then generates a plurality of paths that include a set of lines. Each path may include an identification of the lines in the path, a set of requests, and a weight based on the profit of the set of requests. For example, a path may include multiple lines that fulfill multiple requests of goods or services. The paths identify different combinations of lines that meet a restriction, such as a maximum wait time between requests. Then, some embodiments select a minimum number of paths from the plurality of paths using an optimization that considers the weight of each path.

The use of the paths to optimize the batch of requests reduces the amount of computing resources that are used in addition to increasing the speed of optimization. The paths group lines together and the system considered a fewer number of possible combinations because there are a fewer number of paths to consider compared to the number of lines. By decomposing the complex problem into three phases: a line generator, a path generator, and a delivery optimizer, some embodiments simply the optimization of the delivery optimizer, such as the optimization can be limited to a controlled space and also weights can be applied to the paths. The use of the paths allows a company to process the batch requests faster and more efficiently. Additionally, the optimization allows the company to generate schedules in real-time as requests are received.

System Overview

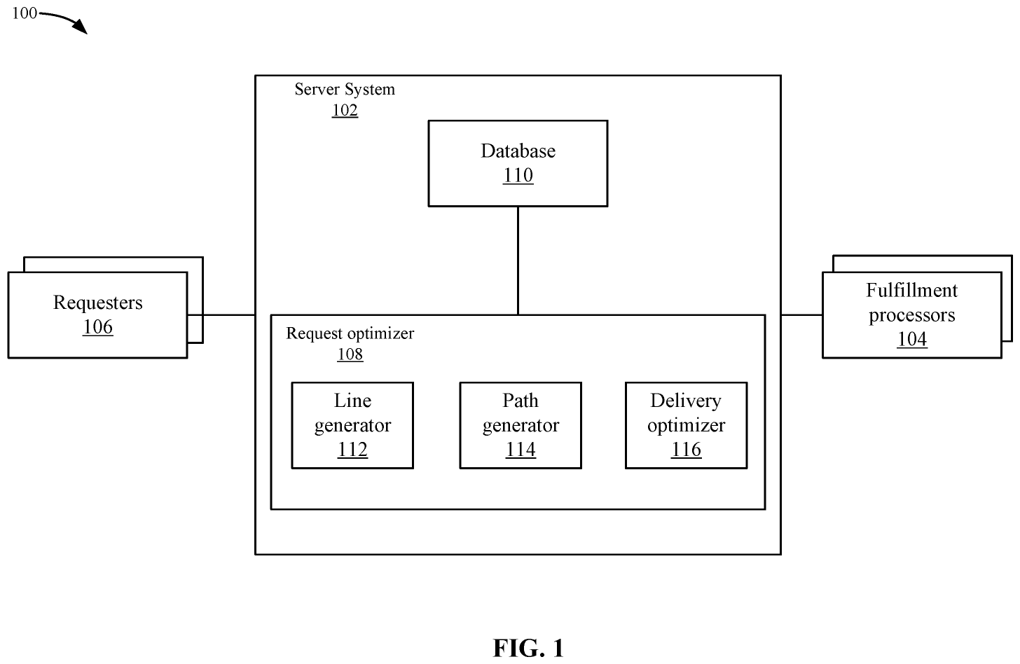

FIG. 1 depicts a simplified system 100 of a method for optimizing requests according to some embodiments. System 100 includes a server system 102, fulfillment processors 104, and requesters 106. Requesters 106 may send requests for goods or services to a company and the company may process the requests at server system 102. In some examples, the requests may be for orders that require transportation routes, such as a delivery service of items (e.g., people or goods) between locations. For example, the company may provide a transportation service, such as picking up customers from different locations, such as the airport, train station, etc., or goods delivery, such as delivering food to users or transporting food between locations.

Fulfillment processors 104 may be entities that fulfill the requests. For example, if the requests are orders for goods transportation, then fulfillment processors 104 may be vehicles that can fulfill the requests. A vehicle may pick up a request at a first location and transport the request to a second location. However, although vehicles may be discussed, fulfillment processors 104 may be other entities, such as messengers.

Server system 102 may receive the requests from requesters 106, optimize the requests via a batch request optimization, and then output the schedule to fulfillment processors 104. The schedule may direct fulfillment processors 104 to fulfill the requests based on the optimization.

A request optimizer 108 optimizes a batch of requests. A database 110 may store information that is used by request processor 108 to optimize the requests. For example, a request may include a request identifier (ID), a pick-up time, time duration, and a price. Request optimizer 108 outputs a schedule that includes a timetable and routes that are used to process the requests. In request optimizer, a line generator 112 receives the requests and can generate a number of lines that are possible from the requests. A line may be associated with a single request and may include duration, an origin and a destination, and a profit-per-unit. Line generator 112 calculates the profit-per-unit based on the price of the request compared to the cost to the company to process the request.

Then, a path generator 114 generates all possible paths using a restriction. In some embodiments, a restriction may be a maximum wait time, such as an amount of time in between the end of the processing of a request and the beginning of the processing of another request. For example, a single vehicle may have a restriction of not waiting more than an hour between multiple requests.

Each of the paths includes a set of lines, which may include a single line or multiple lines. For example, a first path may only include one line that processes one request. The path may include a weight that is derived from the profit. For example, a higher profit may include a higher weight. Another path may include multiple lines that processes multiple requests. The weight may be a combination of the profit for the multiple lines. When multiple requests are combined into a path, the multiple requests in the path meet the restriction that is specified, such as a maximum wait time.

A delivery optimizer 116 receives the paths and can optimize the paths into a schedule that can be used to process the batch of requests. The optimization may select a schedule that maximizes profit while being efficient because the weights are used. Also, optimizing the paths instead of the individual lines improves the processing of the requests. For example, delivery optimizer 116 selects a batch of scheduled routes for the vehicles that optimizes the total profit from the orders and fulfills as many of the orders as batches as possible. The optimization is used to find the optimal subset of paths the covers the orders. Delivery optimizer 116 may optimize the paths in a resource efficient manner. For example, delivery optimizer 116 can use fewer calculations to determine the minimum number of paths that are required to fulfill the orders. Using the smaller amount of paths, delivery optimizer 116 can search for a solution to the optimization in a much smaller subset of paths instead of in the whole space of every line. By decomposing the complex problem into three phases: line generator, path generator and delivery optimizer, some embodiments created a smaller space to perform the optimization. Further, using the weights may allow delivery optimizer to reduce the space even further, such as only the top k paths in terms of the weights between an origin and a destination may be used in the optimization. Additionally, delivery optimizer 116 may use less memory when processing the paths. For example, the number of paths being processed may be fewer than the number of lines and less storage may be needed to store the number of paths in memory. Also, instead of storing the whole feasible space of paths, some embodiments may only cache top k paths for each pair of origin/destination.

Request Optimization Example

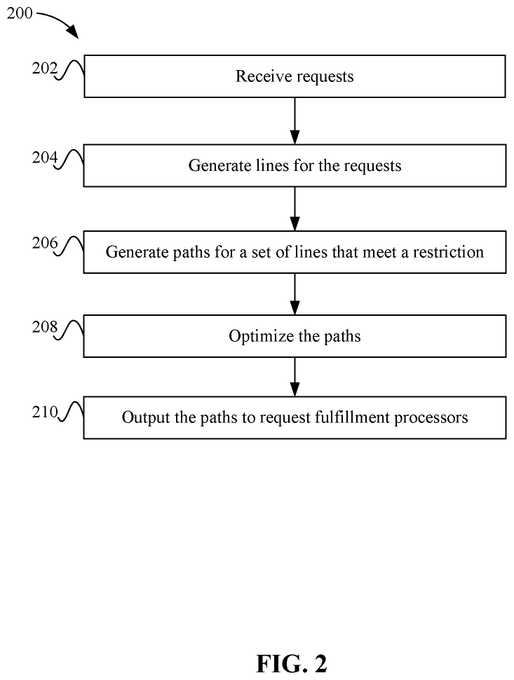

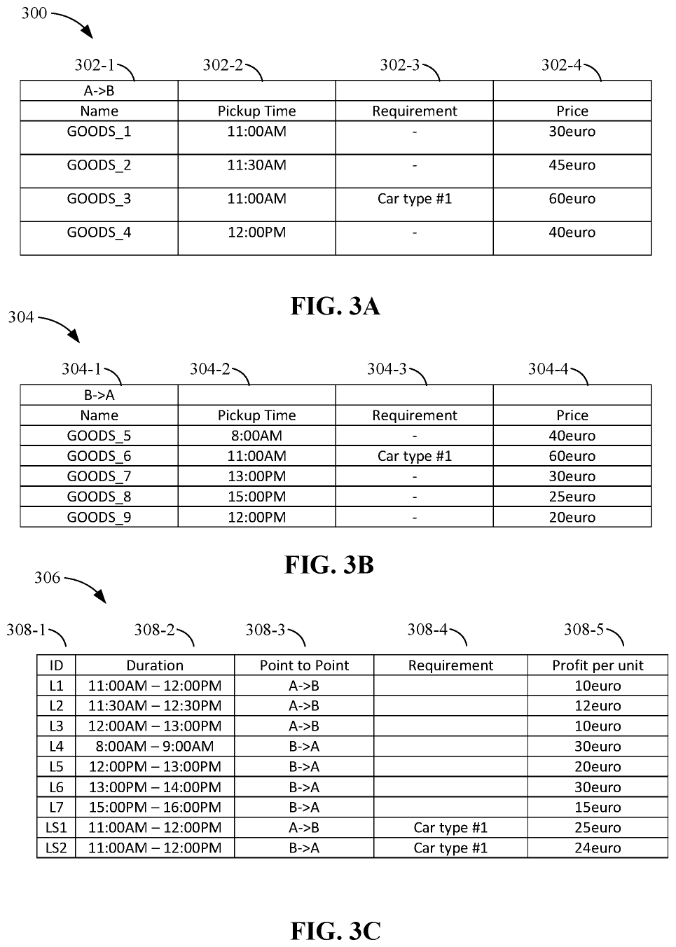

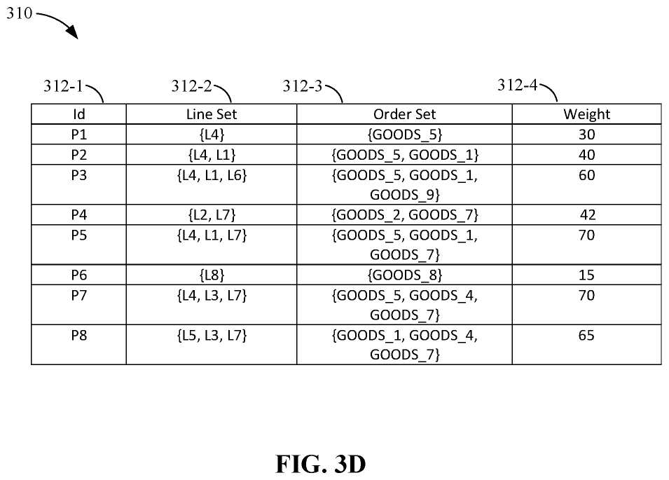

FIG. 2 depicts a simplified flowchart 200 of a method for optimizing requests according to some embodiments. At 202, server system 102 receives requests. The requests may be for a service and the delivery of goods or services will be used as an example. FIG. 3A and FIG. 3B show examples of requests according to some embodiments. FIG. 3A depicts a table 300 that stores information for requests from a first destination (e.g., A) to a second destination (e.g., B) according to some embodiments. FIG. 3B depicts a table 304 that stores information for requests from the second destination to the first destination according to some embodiments. Table 300 includes a first column 302-1 that identifies the request ID (e.g., name); a second column 302-2 that identifies a pick-up time; a third column 302-3 that identifies a requirement; and a fourth column 302-4 that identifies a price. The pick-up time may be the time in which the request fulfillment may start. A requirement may be a special request for the request and the price may be the price that the requester may pay the company. Table 304 may include the same columns as table 300, but the request is between a different origin and destination. For example, the requests start at the second location and end at the first location (B→A). Although only a first location and second location are described, other locations may be appreciated, such as a request may start at the second location and end at a third location.

Each row of tables 300 and 304 may list a request ID (Name), a pick-up time, a requirement (if specified), and a price for a different request. For example, in a first row of table 300, the request for “GOODS_1” has a pick-up time of 11:00 a.m., no requirement, and a price of 30€. Some requests may also specify various requirements. For example, a third request in the third row is for “GOODS_3” and has a pick-up time of 11:00 a.m., with a requirement of a car type #1, and a price of 60€. A car type #1 may specify a type of car, such as a brand of car. Table 304 includes other requests, such as a first row is for “GOODS_5” and has a pick-up time of 8:00 a.m., no requirement, and a price of 40€. The other rows also include other requests.

At 204, line generator 112 of request optimizer 108 generates lines for the requests where each line may be associated with a single request. FIG. 3C shows an example of a table 306 that includes information for the lines that are generated according to some embodiments. Table 306 includes a first column 308-1 that identifies the line, a second column 308-2 that identifies the duration, a third column 308-3 that identifies point-to-point locations, a fourth column 308-4 that identifies any requirements, and a fifth column 308-5 that identifies a profit per unit. The ID column identifies each line individually. An identifier with “L” and a number is a line without a special requirement and an identifier with “LS” and a number is a line with a special requirement. The duration is the time needed to fulfill the request from a start time to an end time. The point-to-point column may identify the origin and the destination. The requirement column may specify any special requirements for the request, such as a car type. The profit-per-unit column is the amount of profit generated by the company when the request is fulfilled. The profit may be calculated based on the price minus the cost to the company.

Each line may correspond to a request. Line L1 corresponds to GOODS_1, line L2 corresponds to GOODS_2, line L3 corresponds to GOODS_4, line L4 corresponds to GOODS_5, line L5 corresponds to GOODS_9, line L6 corresponds to GOODS_7, and line L7 corresponds to GOODS_8. Lines LS1 and LS2 correspond to GOODS_3 and GOODS_6, respectively.

Referring back to FIG. 2, at 206, path generator 114 generates paths that include a set of lines that meet a restriction. In some embodiments, all possible paths are created that meet the restriction. For example, a restriction may be a maximum waiting time and path generator 114 generates paths that do not violate the maximum waiting time. For example, if the maximum waiting time is one hour for the transportation of goods or services, two lines that may not meet the restriction are when one line ends at 1:00 p.m. and then the next line starts at 4:00 p.m. because the waiting time in this example is three hours, which does not meet the one hour maximum waiting time restriction.

The paths may include one or more lines. For example, one path may be line L1 and another path may be line L1 and LX where X is a number. Including more one than one line in the paths creates combinations of lines. As discussed above, the paths are analyzed instead of the lines individually.

FIG. 3D depicts a table 310 that includes information for the paths according to some embodiments. Lines LS1 and LS2 do not have a connection with the normal orders/transport and may be considered as an independent calculation scenario because special vehicles are required. It is possible that if a special vehicle will fulfill one of the paths, then the lines LS1 and LS2 may be included in the optimization. Table 310 includes a first column 312-1 that identifies a path; a second column 312-2 that identifies a line set; a third column 312-3 that identifies a request set; and a fourth column 312-4 that identifies a weight. The identifier identifies a path uniquely. The line set column identifies the lines that are in the path. For example, path P3 includes lines L4, L1, and L6. The request set column identifies the goods or services included in the path. For example, for path P3, the goods GOODS_5, GOODS_1, and GOODS_9 will be fulfilled by this path. The weight is associated with the profit of the lines included in the path. For example, the weight quantifies the amount of profit that the company receives for fulfilling the requests of the path. In some embodiments, the weight is the sum total of the profit for each line in the request set. For example, for path P3, the weight is 60, which corresponds to the profit of 30€+10€+20€. Although the weight is described as being a cumulative accumulation of the profits, the weight may be calculated in different ways.

The paths include different combinations of lines. It is possible that multiple paths include the same line. For example, path P4, P5, P7, and P8 include the line L7. During optimization, delivery optimizer selects the best path that includes line L7.

Referring back to FIG. 2, at 208, delivery optimizer 116 optimizes the paths. In some embodiments, delivery optimizer 116 uses a weighted set covering solution that finds the minimum number of paths that can fulfill the requests. Delivery optimizer 116 can optimize using different objectives. For example, delivery optimizer 116 attempts to maximize the profit by applying a 1/weight per element. Also, if the current objective function is to minimize the cost, delivery optimizer 116 uses “weight” instead of 1/weight.

At 210, request optimizer 108 then outputs the paths to request fulfillment processors 104. For example, the paths that are selected may form a schedule that can be output to fulfillment processors 104. In some examples, if path P3 is selected, then one fulfillment processor 104 can fulfill lines L4, L1, and L6 together, such as a vehicle may be notified to fulfill these lines.

Process Description

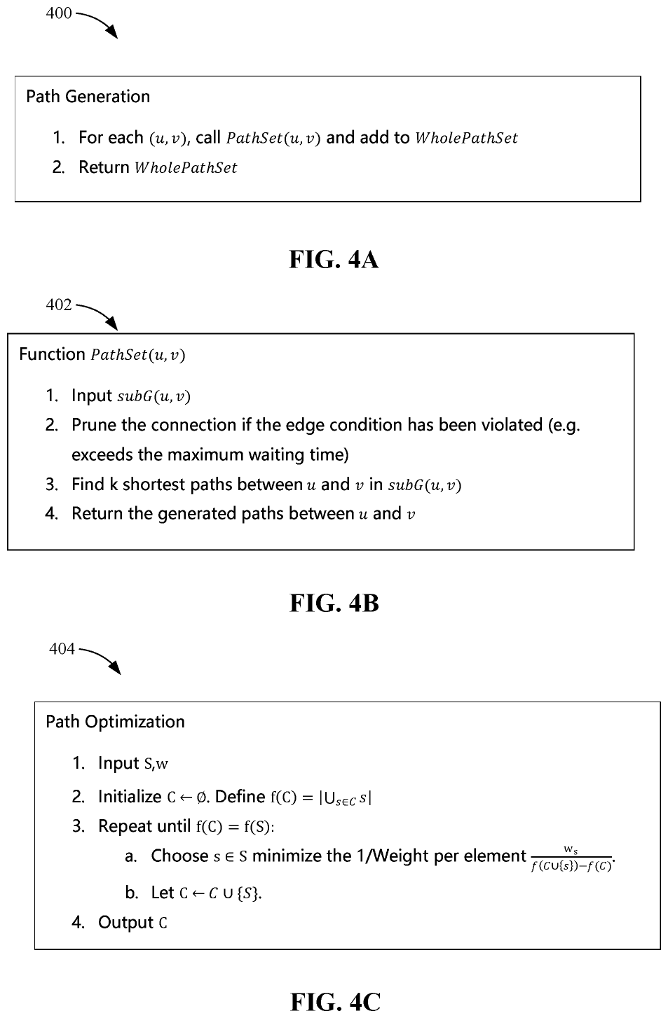

FIGS. 4A to 4C show a description of the process according to some embodiments. FIG. 4A depicts an example of a process 400 that is called to generate the paths according to some embodiments. In the path generation, for each pair of points (u,v), request optimizer 108 calls a process PathSet(u,v) to generate paths that are added to a file WholePathSet. For example, the variable u may be an origin and the variable v may be a destination. Each different origin, destination pair is called. In line #2, once the paths have been generated, the process returns the file WholePathSet.

FIG. 4B shows a process 402 for generating the paths according to some embodiments. In a line #1, an input of subG(u,v) is received. SubG is a sub-graph from a point u to v. For example, the sub-graph may be a line from a point u to point v, which may be two locations. The locations that are used may be restricted to a time period, such as in a 24-hour time period. In that case, the requests within the 24-hour time period are then received as input.

In line #2, a request is pruned from the set if an edge condition has been violated. For example, request optimizer 108 may create a line graph that maps the time duration between locations. The lines for requests may be connected or a connection may be removed. For example, a connection between requests is pruned when a line for a request that connects with another line for a request does not meet a restriction, such as the connection between the lines exceeds the maximum waiting time. For example, request optimizer 108 removes a line that violates the maximum waiting time.

In line #3, request optimizer 108 finds the k shortest paths between u and v in subG (u,v). In one example, the k shortest paths may be based on an algorithm, such as Yen's algorithm. Finding the k shortest paths determines a number of paths from the lines without looping through lines already processed. In line #4, the generated paths are returned.

Once the paths are generated, FIG. 4C depicts a process 404 that optimizes the paths according to some embodiments. In line #1, request optimizer 108 receives an input of (S,w), where S is the path set and w is the weight for each path.

In line #2, request optimizer 108 initializes a variable C as 0 and defines a function f(C) as the |∪_{sec}s|, which is the cardinality for a set union (e.g., a size of the set union). The function f(C) is the number of requests that has been covered previously.

In line #3, request optimizer 108 repeats the following process until f(C)=f(S). That is, the process is repeated until all of the requests have been covered and added to the variable C. Request optimizer 108 iteratively selects the most cost-effective set per the objective using the weight and removes the covered requests, until all requests are covered. In line #3a, request optimizer 108 selects a path S and minimizes the 1/weight per element using

$$\frac{{w}_{s}}{f ( C ⋃ \{ s \} ) - f ( C )} ,$$

where f(C∪{s})−f (C) is the number of goods previously covered in addition to the number of good covered added by the current path minus the number of goods previously covered. In line #3b, the requests for the paths are included in a set C.

In line #4, request optimizer 108 outputs set C, which is the output path set.

In one example, result optimizer 108 initializes a result path variable RESULT_PATH={ } and a covered request variable COVERED_REQUEST={ } to an empty set. The result path variable contains the identification of the paths that are selected. The covered request variable includes the requests that are covered by the paths. The function f(C)=0 identifies a number of requests that have been fulfilled by the covered requests.

Result optimizer 108 selects path P6 since this path has the minimum value (15/(1−0)) of 15 for all the paths according to

$$\frac{{w}_{s}}{f ( C ⋃ \{ s \} ) - f ( C )} .$$

In this case, delivery optimizer 116 minimizes the cost Result optimizer 108 then adds the path P6 to the result path variable: RESULT_PATH={P6}, and adds the goods GOODS_8 that are covered by the path to the covered request variable: COVERED_REQUEST={GOODS_8}. Since one request of goods is added, the function f(C)=1.

Result optimizer 108 then selects path P8 because this path has the minimum value (65/(4−1))=22.5 for all remaining paths. Result optimizer 108 then adds the path P8 to the result path variable: RESULT_PATH={P6, P8}, and adds the goods GOODS_1, GOODS_4, GOODS_7 that are covered by the path to the covered request variable: COVERED_REQUEST={GOODS_1, GOODS_4, GOODS_7, GOODS_8}. Path P8 covered three lines {L5, L3, and L7} and the corresponding goods for those lines are added to the covered requests. The variable f(C)=4 because the number of goods added is four.

Result optimizer 108 then selects path P3 because this path has the minimum value (60/(6−4))=30 for all remaining paths. In this case, the one with larger cardinality is selected (e.g., the greatest number of lines). Result optimizer 108 then adds the path P3 to the result path variable: RESULT_PATH={P6, P8, P3}, and adds the goods GOODS_5, GOODS_1, GOODS_9 to the covered request variable: COVERED_REQUEST={GOODS_1, GOODS_4, GOODS_5, GOODS_7, GOODS_8, GOODS_9}. Path P3 covered three lines {L4, L1, L6} and the corresponding goods for those lines are added to the covered requests. The variable f(C)=6 because the number of goods added is six.

Result optimizer 108 then selects path P4 because this path has the minimum value (42/(7−6))=42 for all remaining paths. Result optimizer 108 then adds the path P6 to the result path variable: RESULT_PATH={P6, P8, P3, P4}, and adds the goods GOODS_2, GOODS_7 to the covered request variable: COVERED_REQUEST={GOODS_1, GOODS_2, GOODS_4, GOODS_5, GOODS_7, GOODS_8, GOODS_9}. Path P4 covered three lines {L2, L7} and the corresponding goods for those lines are added to the covered requests. The variable f(C)=8 because the number of goods added is eight. GOODS_3 and GOODS_6 include special requirements and are not considered for this optimization. In the above optimization, delivery optimizer 116 selects four paths out of the eight possible paths to cover the requests. The calculation is more efficiently performed because the optimization only involves selecting among eight paths using the associated weights. Optimizing the paths is more efficient than attempting to optimize the individual lines.

Example System

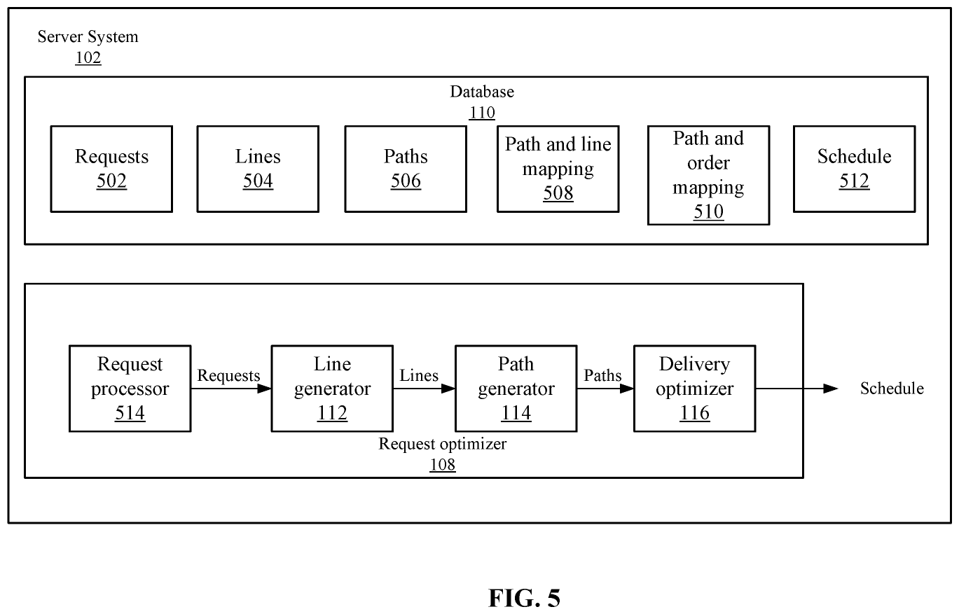

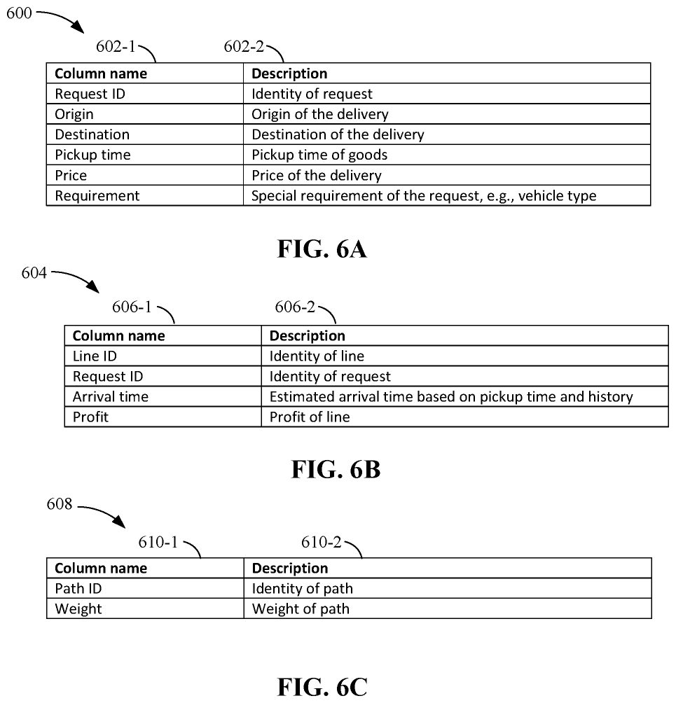

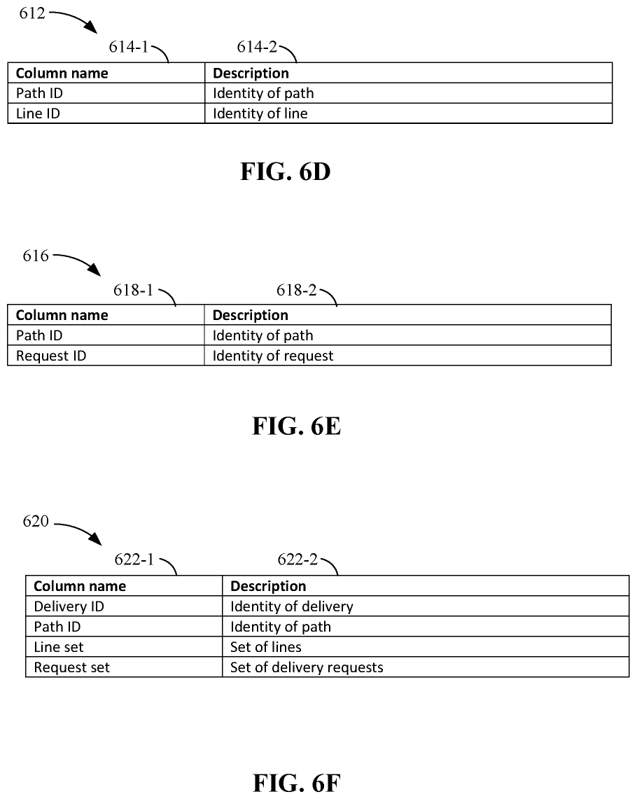

FIG. 5 depicts a more detailed example of server system 102 according to some embodiments. A request processor 514 receives the requests and can generate information for requests, which are stored in database 110 as requests 502. Requests 502 may include information for the requests that are needed by line generator 112. FIG. 6A shows a table 600 that is stored for each request according to some embodiments. Table 600 includes a first column 602-1 for a column name and a second column 602-2 for a description of the column name. The column names include a request ID, an origin, a destination, a pick-up time, a price, and a requirement. The request ID is the identity of the request, the origin is the origin of the delivery, the destination is the destination of delivery, the pick-up time is the pick-up time of the goods, the price is the price of the delivery, and the requirement is any special requirement for the request, such as vehicle type.

Line generator 112 then receives the information for requests 502 and can generate information for lines that is stored in database 110 as lines 504. FIG. 6B depicts an example of a table 604 that summarizes information for the lines according to some embodiments. Table 604 includes a first column 606-1 that identifies a column name and a second column 606-2 that identifies a description for the column name. The columns include a line ID, a request ID, an arrival time, and a profit. The line ID is the identity of the line; the request ID is the identity of the request; the arrival time is an estimated arrival time based on the pick-up time and a previous history; and the profit is the profit for the line. The history may be used to estimate the arrival time from other, similar routes or previous routes that have been taken.

Path generator 114 receives the information for lines 504 and then can generate information for paths that is stored in database 110 as paths 506. FIG. 6C depicts an example of a table 608 that describes the paths according to some embodiments. Table 608 includes a first column 610-1 that includes a column name and a second column 610-2 that includes a description for the column name. The column names include a path ID that identifies the identity of the path and a weight that identifies the weight of the path. When processing the path IDs, path generator 114 may add paths to table 608.

Delivery optimizer 116 then optimizes the paths and generates information for a path and line mapping 508, a path and request mapping 510, and a schedule 512, which are all stored in database 110. FIG. 6D depicts a table 612 that maps paths to lines according to some embodiments. Table 612 includes a first column 614-1 that identifies a column name and a second column 614-2 that identifies a description for the column name. The column names include a path ID that identifies the path and a line ID that identifies a line. The table associates a map between the path ID and the line ID.

FIG. 6E depicts a table 616 in database 110 that maps paths to requests according to some embodiments. Table 616 maps a path to a request and includes a first column 618-1 that describes a column name and a second column 618-2 that includes a description for the column name. The columns include a path ID that describes an identity of the path and a request ID that describes an identity of the request.

Delivery optimizer 116 then generates a schedule, which is stored in database 110 as schedule 512. FIG. 6F depicts a table 620 that describes a schedule according to some embodiments. Table 620 includes a first column 622-1 that describes a column name and a second column 622-2 that includes a description for the column names. The column names may include a delivery ID that describes the identity of a delivery, a path ID that describes an identity of the path, a line set that describes a set of lines, and a request set that describes a set of delivery requests. A delivery schedule may include multiple tables 620 that identify the paths, a line set, and request set that can be scheduled. For example, one table may include a path P8 that covers lines L5, L3, and L7 with the requests of GOODS_1, GOODS_4, and GOODS_7.

### CONCLUSION

Accordingly, some embodiments can generate a schedule that optimizes the requests received. The optimization may select the schedule using less computing resources and more efficiently because lines and paths are generated first, and then the schedule is optimized using the paths that are generated based on the lines.

System

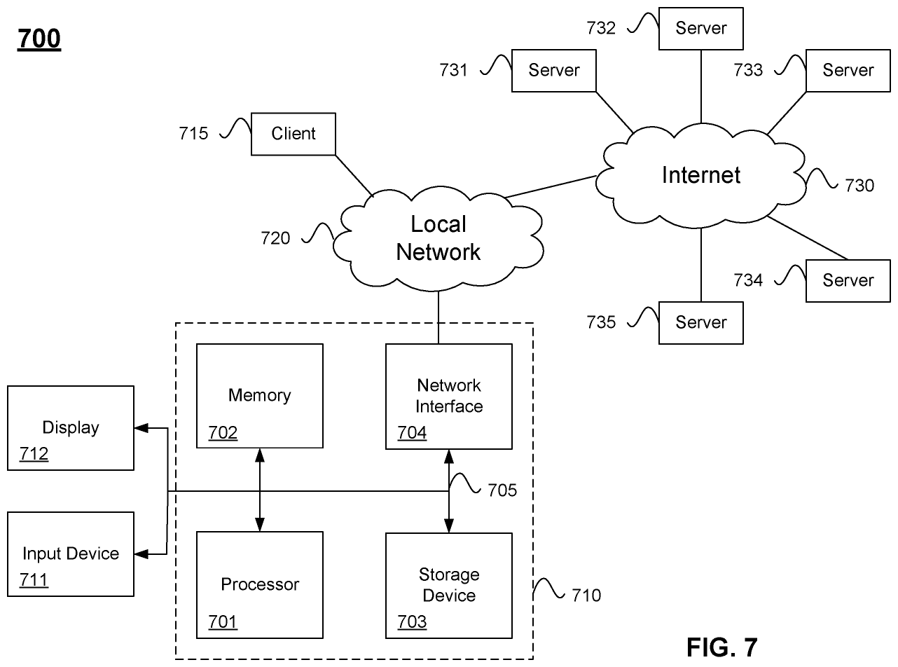

FIG. 7 illustrates hardware of a special purpose computing machine configured with request optimizer 108 according to one embodiment. An example computer system 710 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable storage mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information through the network interface 704 across a local network 720, an Intranet, or the Internet 730. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, a plurality of requests, wherein each request includes an origin, a destination, a time dependency, a request, and a cost of the request;
generating, by the computing device, a plurality of lines from the requests, each line including a duration from the time dependency, the origin, the destination, and a profit based on the cost;
generating, by the computing device, a plurality of paths including a set of lines, each path including an identification of the lines in the path, a set of requests in the path, and a weight based on the profit of the set of requests in the path; and
analyzing, by the computing device, the plurality of paths to select a number of paths from the plurality of paths based on the weight of each path; and
outputting, by the computing device, a fulfillment schedule to fulfill the requests, wherein a combination of requests is assigned to a single fulfillment entity based on a set of requests in a path selected for the single fulfillment entity.

2. The method of claim 1, wherein analyzing the plurality of paths comprises:
selecting, by the computing device, a first path based on an objective that is used to select the first path over other paths in the plurality of paths based on weights of the first path and the plurality of paths; and
adding, by the computing device, the first path to the fulfillment schedule.

3. The method of claim 2, wherein adding the first path to the fulfillment schedule comprises:
determining, by the computing device, the lines associated with the first path; and
adding, by the computing device, the lines to a first variable for the requests that are covered by the path.

4. The method of claim 3, wherein adding the first path to the fulfillment schedule comprises:
adding, by the computing device, the first path to a second variable that includes the paths added to the fulfillment schedule.

5. The method of claim 4, wherein analyzing the plurality of paths comprises:
continuing, by the computing device, to selecting other paths that are not in the second variable, adding the other paths to the fulfillment schedule, adding the lines for the other paths to the first variable, and adding the other paths to the second variable until the first variable includes all the requests.

6. The method of claim 1, wherein analyzing the plurality of paths comprises:
selecting, by the computing device, a path from the plurality of paths that minimizes a value of 1/weight for each path.

7. The method of claim 6, wherein the path is selected based on:
$$\frac{{w}_{s}}{f ( C ⋃ \{ s \} ) - f ( C )} ,$$
where wₛ is the weight and f(C∪{s})−f(C) is a number of goods previously covered in addition to a number of good covered added by the path minus the number of goods previously covered.

8. The method of claim 1, wherein:
multiple paths include the same line, and
only one path in the multiple paths is selected and added to the fulfillment schedule.

9. The method of claim 1, wherein the weight for a path is a cumulative value for weights of lines included in the path.

10. The method of claim 1, wherein the plurality of paths are analyzed instead of the plurality of lines to generate the fulfillment schedule.

11. The method of claim 1, wherein the profit is based on revenue generated by fulfilling the request and the cost of the request.

12. The method of claim 1, wherein generating the plurality of paths comprises:
applying, by the computing device, a restriction to the plurality of lines to generate different combinations of lines that meet the restriction.

13. The method of claim 12, wherein the plurality of requests are to be fulfilled in a time period.

14. A non-transitory computer-readable storage medium containing instructions, that when executed, control a computer system to be configured for:
receiving a plurality of requests, wherein each request includes an origin, a destination, a time dependency, a request, and a cost of the request;
generating a plurality of lines from the requests, each line including a duration from the time dependency, the origin, the destination, and a profit based on the cost;
generating a plurality of paths including a set of lines, each path including an identification of the lines in the path, a set of requests in the path, and a weight based on the profit of the set of requests in the path; and
analyzing the plurality of paths to select a number of paths from the plurality of paths based on the weight of each path; and
outputting a fulfillment schedule to fulfill the requests, wherein a combination of requests is assigned to a single fulfillment entity based on a set of requests in a path selected for the single fulfillment entity.

15. The non-transitory computer-readable storage medium of claim 14, wherein analyzing the plurality of paths comprises:
selecting a first path based on an objective that is used to select the first path over other paths in the plurality of paths based on weights of the first path and the plurality of paths; and
adding the first path to the fulfillment schedule.

16. The non-transitory computer-readable storage medium of claim 15, wherein adding the first path to the fulfillment schedule comprises:
determining, by the computing device, the lines associated with the first path; and
adding, by the computing device, the lines to a first variable for the requests that are covered by the path.

17. The non-transitory computer-readable storage medium of claim 14, wherein analyzing the plurality of paths comprises:
selecting a path from the plurality of paths that minimizes a value of 1/weight for each path.

18. The non-transitory computer-readable storage medium of claim 14, wherein:
multiple paths include the same line, and
only one path in the multiple paths is selected and added to the fulfillment schedule.

19. The non-transitory computer-readable storage medium of claim 14, wherein the plurality of paths are analyzed instead of the plurality of lines to generate the fulfillment schedule.

20. An apparatus comprising:
one or more computer processors; and
a non-transitory computer-readable storage medium comprising instructions, that when executed, control the one or more computer processors to be configured for:
receiving a plurality of requests, wherein each request includes an origin, a destination, a time dependency, a request, and a cost of the request;
generating a plurality of lines from the requests, each line including a duration from the time dependency, the origin, the destination, and a profit based on the cost;
generating a plurality of paths including a set of lines, each path including an identification of the lines in the path, a set of requests in the path, and a weight based on the profit of the set of requests in the path; and
analyzing the plurality of paths to select a number of paths from the plurality of paths based on the weight of each path; and
outputting a fulfillment schedule to fulfill the requests, wherein a combination of requests is assigned to a single fulfillment entity based on a set of requests in a path selected for the single fulfillment entity.
